(19) United States
(12) Patent Application Publication
(10) Pub. No.: US 2026/0357660 A1
(43) Pub. Date: Nov. 12, 2026

(54) Hard Metal Tip for a Drilling Tool; Drilling Tool Having a Hard Metal Tip

(71) Applicant: Robert Bosch GmbH, Stuttgart (DE)

(72) Inventors: Tamara Gaschler, Weingarten (DE); Xiao Qiu, Weingarten (DE); Stefan Sonntag, Vogt (DE); Rainer Widmann, Bodnegg (DE)

(21) Appl. No.: 19/114,781

(22) PCT Filed: Sep. 12, 2023
(86) PCT No.: PCT/EP2023/075042

§ 371 Date: Mar. 24, 2025

(30) Foreign Application Priority Data
Sep. 30, 2022 (DE) 10 2022 210 423.4

(51) Int. Cl. E21B 10/46

(52) U.S. Cl. CPC E21B 10/46

(57) ABSTRACT

A carbide head, particularly a carbide head for a drilling tool, includes at least one cutting edge and a joining surface for connecting the carbide head to a main body of the drilling tool. The carbide head includes at least one closed suction channel.

### PRIOR ART

DE 10 2019 205 656 A1 describes a rock drill with a transport channel arranged radially between a main body and a sleeve element and having a solid carbide head.

### DISCLOSURE OF THE INVENTION

The invention relates to a carbide head, in particular to a carbide head for a drilling tool, comprising at least one cutting edge and a joining surface for connecting the carbide head to a main body of the drilling tool. It is proposed that the carbide head comprises at least one closed suction channel. Advantageously, the suction performance and robustness can be optimized thereby.

The drilling tool is in particular designed as a rock drill provided for a hammer drill. At its end facing away from the drilling head, the drilling tool in particular has an insertion end designed to be coupled to a hand-held tool machine such as a drill hammer. Preferably, the drilling tool in the region of the insertion end is designed such that the drilling tool is couplable to a tool receptacle of the hand-held tool machine. The drilling tool in the region of the insertion end can, e.g., comprise interlocking elements designed as special grooves that form an SDS plus interface or an SDS max interface. However, other types of insertion ends would also be conceivable, for example a round shaft, a hex shaft, etc. To machine a part, the drilling tool is placed in a rotating as well as linearly oscillating or striking state by means of the drill hammer. The drilling tool penetrates the workpiece during machining in the feeding direction of the drilling tool. The feeding direction of the drilling tool is coaxial to a longitudinal axis of the drilling tool and starting from the insertion end towards the drilling head. In particular, the longitudinal axis of the drilling tool corresponds to a working or rotational axis of the drilling tool. The longitudinal axis of the drilling tool is preferably coaxial or parallel to an axis of rotation of the carbide head when connected.

The carbide head is in particular formed as a cutting body. The cutting body comprises at least one cutting element, which can be configured as a main cutting element or an auxiliary cutting element. The carbide head is preferably formed as a solid carbide head and is thus integral and consists of a hard material. For example, the hard material may be a carbide, as a ceramic, as a cermet, or the like. Preferably, the carbide head has a higher hardness than the main body of the drilling tool. Each cutting element comprises at least one cutting edge. The cutting edge corresponds to the intersection line of a cutting surface and a free surface of the cutting element. Preferably, each cutting element comprises a single cutting edge. Alternatively, the cutting element can also comprise a plurality of cutting edges, which in particular transition into one another. The connection between the carbide head and the drilling tool is in particular performed via a bonded connection in the area of the joining surface. Preferably, the bonded connection is completed via a welded connection. Alternatively, a soldered connection of the carbide head to the main body of the drilling tool is also conceivable. In this context, the weld joint differs from the solder joint in particular in that in the weld joint, the components to be connected are partially melted.

In the context of this application, a closed suction channel is to be understood to mean in particular a suction channel radially surrounded by material. The radial direction is substantially perpendicular to an axis of rotation of the carbide head.

The main body of the drilling tool is preferably connected to the carbide head in a bonded fashion. The drilling tool preferably comprises at least one transport channel. The transport channel is configured to extract drill debris or drill dust generated during machining of a part from the drill hole. In particular, the transport channel spans a transport area, wherein the transport region is connected in a fluidic manner to a connection region for a suction device. The main body may be configured such that the main body does not intersect the longitudinal axis of the drilling tool in the transport region. In particular, the main body axially adjoins the carbide head at least partially, preferably completely. The main body is in particular designed to transfer an impact pulse from the hand-held tool machine to the drilling head. The main body consists of a metallic material, in particular a steel. The main body is in particular rotationally connected to the insertion end. The main body can be designed to be integral with the insertion end.

The transport channel of the drilling tool is in particular designed to transport a fluid, preferably an air flow, within the drilling tool. The transport channel is preferably provided for the suction of drill debris within a drill hole during a drilling operation. The drill debris is preferably transported in a direction contrary to the feeding direction of the drilling tool. The transport channel comprises a suction inlet and a suction outlet, the distance between which corresponds to the length of the transport channel. The suction inlet is in particular arranged in the region of the carbide head, preferably directly behind the carbide head. The transport channel can be formed eccentrically or concentrically. An eccentric or concentric transport channel is to be understood in particular as a transport channel that runs at least 70% of its length, preferably at least 90% of its length, preferably substantially entirely along its length, eccentrically or concentrically to the longitudinal axis of the drilling tool. The drill debris can enter the transport channel via the suction inlet. The drilling tool may comprise one or more suction inlets. The suction inlet and the suction outlet can be located substantially parallel to each other, preferably substantially perpendicular to each other.

In particular, the connecting region comprises at least one connection element designed to connect the drilling tool to a suction removal adapter. Preferably, in the connected state, the suction removal adapter is designed to be partially movable with respect to the drilling tool, in particular movable with respect to the main body of the drilling tool. In particular, the suction removal adapter is axially fixed and rotatably connected such that the suction removal adapter is axially substantially fixed to the drilling tool and the drilling tool can rotate inside the suction removal adapter. In particular, the suction removal adapter is fixed to the drilling tool, with a clearance being provided. The suction outlet can be located in the connecting region. Preferably, the transport channel is partially located in the connection region. The suction adapter has a suction device interface for connection to a suction device, in particular for connection to a suction hose of the suction device.

Furthermore, it is proposed that the suction channel has an input opening and an output opening. In particular, the input opening is arranged on a first side comprising the at least one cutting edge and the output opening is arranged on a second side opposite the first side and comprising the joining surface. Advantageously, a particularly effective transport of drill debris can be ensured. In particular, the output opening is arranged such that the output opening of the carbide head can be connected to the suction inlet of the drilling tool.

It is further proposed that the at least one suction channel has a circular or oval cross section. Advantageously, good suction performance can be ensured as a result. Alternatively, it is also conceivable that the cross section is triangular, square, rectangular or the like, wherein the corners are preferably round, or have radii.

It is also proposed that the at least one suction channel has a cross section that is constantly formed. Advantageously, the suction performance can be further optimized thereby. Alternatively, it is also conceivable for the suction channel to be partially or completely conical, wherein the cross-section preferably increases towards the joining surface. Alternatively, a reduction in size is also conceivable. It is also contemplated that the suction channel partially extends with a substantially constant cross-section and opens conically in the direction of the joining surface. Advantageously, clogging of the suction channels can thereby be counteracted.

Furthermore, it is proposed that the carbide head comprises at least two cutting edges, in particular at least four cutting edges, extending radially outward, wherein the cutting edges each have a radially outward end, wherein the radially outward ends of the cutting edges are connected via a connecting element. Advantageously, the mechanical robustness of the carbide head can thereby be increased. In particular, the carbide head is configured such that the connecting element has a greater distance from the axis of rotation than the suction channel. The cutting edges of the carbide head may have equal lengths or different lengths.

It is further proposed that the connecting element is formed as a segmented circle. As a result, robustness can be further improved in an advantageous manner. Alternatively, it is also contemplated that the connecting element is partially or completely straight, wavy and/or curved inward.

In addition, it is proposed that the cutting edge is associated with a blade having a free surface and a cutting surface. In particular, the suction channel is disposed at least partially, in particular completely, in the free surface of the blade. Advantageously, the removal performance can be optimized as a result.

Furthermore, it is proposed that the suction channel is disposed spaced apart from the cutting surface. Advantageously, the removal performance can be further optimized as a result. The suction channel may be disposed between the free surface and the cutting surface. Alternatively, it is also contemplated that the suction channel is substantially entirely disposed between the free surface and the cutting surface.

Furthermore, the invention relates to a drilling tool having a carbide head as previously described, wherein the drilling tool comprises a joining surface corresponding to the joining surface of the carbide head, which comprises at least one suction inlet of a transport channel of the suction drill. Advantageously, the drilling dust can thereby be transported via the carbide head out of the drill hole.

In addition, it is proposed that the carbide head comprises a single suction channel per transport channel of the drilling tool. Advantageously, maximum robustness of the drilling tool can thereby be ensured.

Furthermore, it is proposed that the carbide head comprises at least two suction channels per transport channel of the drilling tool. Advantageously, the removal performance can be optimized as a result.

Furthermore, it is proposed that the carbide head comprises at least one single suction channel connected to at least two transport channels of the drilling tool.

### DRAWINGS

Further advantages follow from the description of the drawings below. The drawings, the description, and the claims contain numerous features in combination. A person skilled in the art will appropriately also consider the features individually and combine them into additional advantageous combinations.

The figures show:

FIG. 1 a side view of a system consisting of a hand-held tool machine with a drilling tool connected to a suction removal device via a suction removal adapter;

FIG. 2 a perspective view of a drilling tool having a carbide head;

FIG. 3 a perspective view of the carbide head according to FIG. 2;

FIG. 4 a sectional view through the carbide head in the state connected with the drilling tool.

### DESCRIPTION OF THE EXEMPLARY EMBODIMENTS

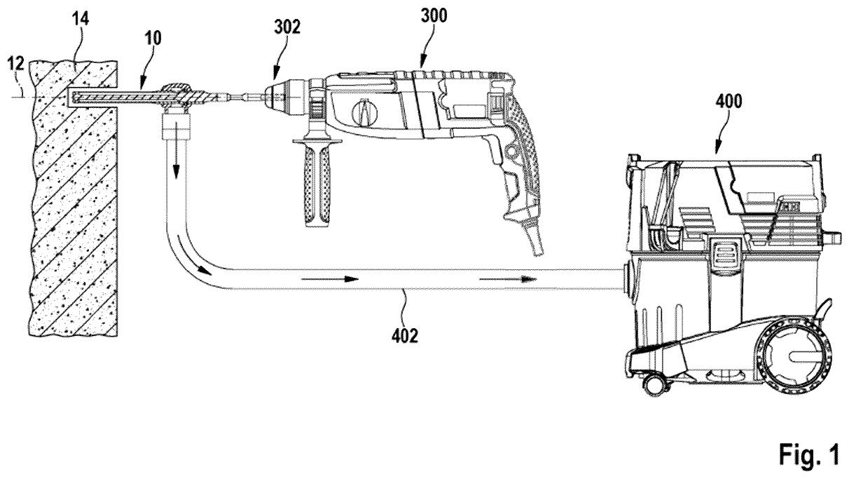

A schematic view of a tool system is shown in FIG. 1. The tool system comprises a drilling tool 10, a hand-held tool machine 300, and a suction removal device 400. The hand-held tool machine 300 is configured as a drill hammer. The hand-held tool machine 300 comprises a tool receptacle 302 designed to receive an insertion tool, for example configured as a drilling tool 10. The hand-held tool machine 300 comprises a power unit (not shown) and a transmission comprising a pneumatic percussion mechanism. The power unit and the transmission can be used to drive the drilling tool 10 in the coupled state rotationally about a longitudinal axis 12 of the drilling tool 10 and linearly oscillate or impact along the longitudinal axis 12.

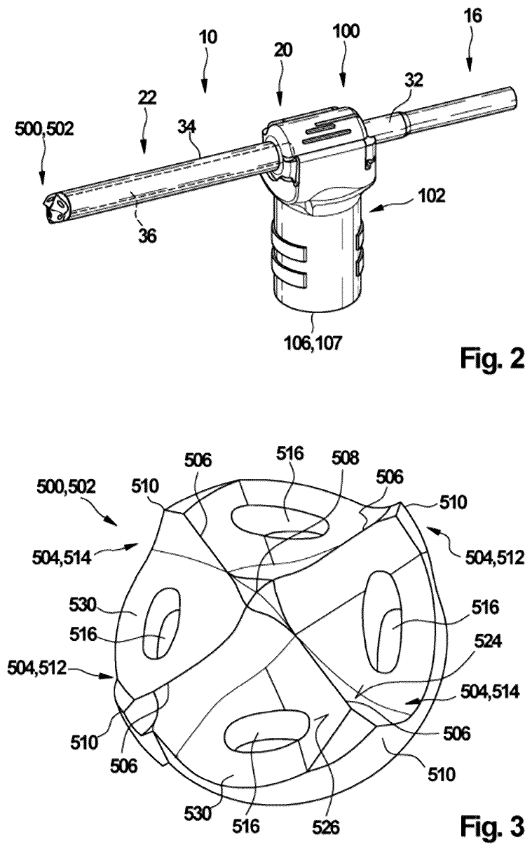

The drilling tool 10 is designed as a rock drill and is shown in an enlarged perspective view in FIG. 2. The drilling tool 10 is in particular designed as a suction drill, via which dust and drill debris can be suctioned from the drill hole during the drilling operation. The drilling tool 10 is particularly provided to generate a drill hole in a workpiece 14, e.g., in the form of a wall. The drill hole is generated via a striking motion of the drilling tool 10 along the longitudinal axis 12 and a rotational motion of the drilling tool 10 about the longitudinal axis 12. The drilling tool 10 has a cutting body 500 at a first end in the form of a carbide head 502. The drilling tool 10 also comprises an insertion end 16 at a second end opposite to the first end designed to connect the drilling tool 10 to the hand-held tool machine 300. The insertion end 16 of the drilling tool 10 has, e.g., a smaller diameter than the carbide head 502. The insertion end 16 is exemplarily designed as a round shaft.

Starting from the insertion end 16, the drilling tool 10 comprises a connection region 20 along its longitudinal extension for connecting the drilling tool 10 to a suction removal adapter 100, a transport region 22, and the carbide head 502. The suction removal adapter 100 is connected to the suction removal device 400 (designed, e.g., as an industrial vacuum) via a suction hose 402.

The suction removal adapter 100 comprises, by way of example, a housing 102 and a tool connection unit for axially fixing the suction removal adapter 100 to the drilling tool 10. The housing 102 comprises a suction device interface 106 for releasable connection to the suction device 400. The suction device interface 106 is configured, e.g., as a suction socket 107. The suction socket 107, by way of example, has a conical interior for connection to the suction hose 402. The suction removal adapter 100 and the drilling tool 10, in particular a main body 32 of the drilling tool 10 are rotatably connected in relation to each other.

The drilling tool 10 comprises a main body 32 and a cover element 34 in the transport region 22. Radially located between the main body 32 and the cover element 34 are, for example, four transport channels 36 for transporting drill debris from the drill hole. The cover element 34 is, e.g., fixed and non-rotationally connected to the suction removal adapter 100. The cover element 34 is disposed entirely outside of the main body 32.

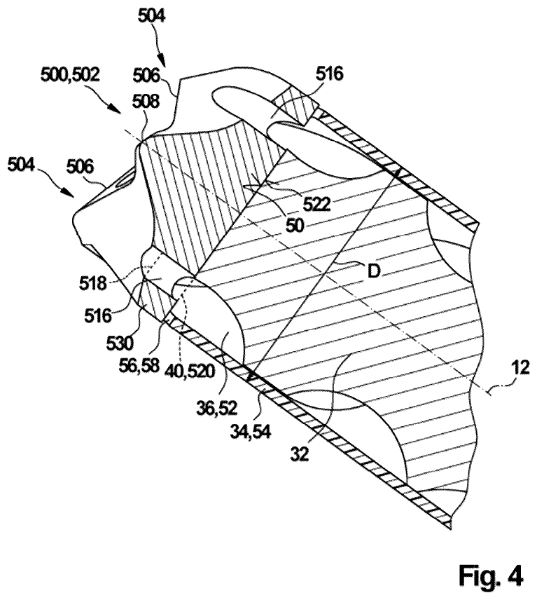

The transport channels 36 extend along the longitudinal axis 12 completely through the transport region 22. By way of example, the transport channels 36 each comprise a suction inlet 38 (see FIG. 4), through which drill debris enters the transport channel 36 during the generation of the drill debris, and a suction outlet (not shown), through which the drill debris exits the transport channel 36. The suction outlet is in this case located inside the suction removal adapter 100. It is also contemplated that the drilling tool 10 may comprise a single transport channel, two or three transport channels, or more than four transport channels.

The carbide head 502 is shown in a perspective view in FIG. 3. The carbide head 502 is made of one piece and is made entirely of a carbide, for example a carbide comprising a tungsten carbide, which is joined to a binder, for example, cobalt. The carbide head 502 comprises, by way of example, four blades 504. The blades 504 each have a cutting edge 506. The cutting edges 506 extend substantially straight. The cutting edges 506 are joined by way of example radially inward by a single tip 508. The tip 508 is arranged by way of example to be intersected by the longitudinal axis 12 of the drilling tool 10.

The cutting edges 506 have a radially outward end 510. The carbide head 502 comprises, by way of example, two main cutting edges 512 and two ancillary cutting edges 514, wherein the radially outward ends 510 of the cutting edges 506 of the main cutting edges 512 have a greater distance from the tip 508 than the radially outward ends 510 of the cutting edges 506 of the ancillary cutting edges 514. The main cutting edges 512 also, by way of example, each have a wear mark.

In addition, the carbide head 502 comprises, by way of example, four suction channels 516. The suction channels 516 are formed as closed and surrounded by material between an input opening 518 (see FIG. 4) disposed on one side of the carbide head 502 with the cutting edges 506 and an output opening 520 (see FIG. 4) disposed on one side of the carbide head 502 with a joining surface 522.

The suction channels 516 are substantially oval shaped when viewed in cross-section. The cross section of the suction channels 516 is substantially constant in the closed area. In the area of the input opening 518, the suction channel 516 is laterally opened so that the cross section is increased.

The suction channels 516 are preferably arranged such that when viewed in the direction of rotation, a single suction channel 516 is arranged between two cutting edges 506, respectively. The blades 504 each have a cutting surface 524 and a free surface 526 separated from each other by the cutting edge 506. The suction channels 516, in particular the input openings 518 of the suction channels 516, are preferably spaced apart from the cutting surfaces 524 of the cutting edges 504. In addition, the suction channels 516 are exemplary arranged such that they are arranged between the cutting surface 524 and the free surface 526 and partially overlap with the free surface 526. The arrangement of the suction channels 516 in the open surfaces 526 results in the partial opening of the suction channel 516 in the area of the input opening 516.

The radially outward ends 510 of the cutting edges 506 are connected to the radially outward ends 510 of the directly adjacent cutting edges 506 via a connecting element 530. The connecting elements 530 extend, by way of example, as a segmented circle between the cutting edges 506. The connecting elements 530 always have a greater radial distance from the longitudinal axis 12 and/or the tip 508 of the carbide head 502 than the suction channels 516. By way of example, each connecting element 530 partially comprises the free surface 526 and the cutting surface 524 of different cutting edges 504.

FIG. 4 shows a side view of the carbide head 502 in the state connected to the drilling tool 10. The carbide head 502 is via the joining surface 522 with a corresponding blunt joining surface 50 of the drilling tool 10 disposed at a face end of the main body 32 of the drilling tool 10. The joining surfaces 522, 50 corresponding to each other extend substantially perpendicular to the longitudinal axis 12 of the drilling tool 10.

The main body 32 of the drilling tool 10 has helical grooves 52, for example, for removing drill debris. The grooves 52 are covered by the cover element 34, with the cover element 34 configured, for example, as a sleeve 54. The sleeve 54 is exemplary formed from a plastic, but a metallic sleeve could also be contemplated. It is also contemplated that the grooves 52 may be partially or completely straight.

The carbide head 502 is connected to the main body 32 of the drilling tool 10 such that the suction channels 516 of the carbide head 502 transition into the transport passages 36 of the main body 32 or are connected to each other in a fluidic manner. In particular, the output opening 520 of the carbide head 502 directly abuts the suction outlet 40 of the main body 32.

By way of example, the cover element 34 has a diameter D that substantially corresponds to a maximum distance between two opposing connecting elements 530. By way of example, the cover element 34 does not extend completely to the plane of the joining surface 50 of the main body 32, but rather terminates with a small axial offset from the joining surface 50. The offset creates a gap 56 between the carbide head 502, particularly the connecting element 530 of the carbide head 502, and the cover element 34. The gap 56 is preferably formed as an optional flow bypass 58 through which additional air may enter the transport channel 36 directly and without the suction channel 516.

During machining of the part 14, the drilling tool 10, in particular the carbide head 502 and the main body 32, are driven rotationally and/or in a linearly oscillating manner. The cover element 34 is fixedly connected to the suction removal adapter 100, wherein air flow is generated by the suction device 400, through which the resulting drill debris is sucked out of the part 14 via the suction channels 516 in the carbide head 502 into the transport channel 36 of the drilling tool 10.

1. A drilling tool, comprising:
a main body; and
a carbide head including (i) at least one cutting edge, and (ii) a joining surface configured to connect the carbide head to the main body,
wherein the carbide head comprises at least one closed suction channel.

2. The drilling tool of claim 1, wherein the at least one closed suction channel has an input opening and an output opening.

3. The drilling tool of claim 2, wherein the input opening is arranged on a first side comprising the at least one cutting edge and the output opening is arranged on a second side opposite the first side and comprising the joining surface.

4. The drilling tool of claim 1, wherein the at least one closed suction channel has a circular or oval cross-section.

5. The drilling tool according to claim 1, wherein the at least one closed suction channel has a cross section that is constantly formed.

6. The drilling tool of claim 1, wherein the carbide head includes at least four cutting edges extending radially outward, wherein each of the cutting edges has a radially outward end, and wherein the radially outward ends of the cutting edges are connected via a connecting element.

7. The drilling tool of claim 6, wherein the connecting element is formed as a segmented circle.

8. The drilling tool of claim 1, wherein the at least one cutting edge is associated with a blade having a free surface and a cutting surface.

9. The drilling tool of claim 8, wherein the at least one closed suction channel is disposed entirely in the free surface of the blade.

10. The drilling tool of claim 8, wherein the at least one closed suction channel is disposed spaced apart from the cutting surface.

11. A drilling tool, comprising:
a main body having a first joining surface;
a carbide head including (i) at least one cutting edge, and (ii) a second joining surface configured to connect the carbide head to the main body, wherein the carbide head comprises at least one closed suction channel; and
a second joining surface corresponding to the first joining surface, the second joining surface comprising at least one suction inlet of a transport channel.

12. The drilling tool according to claim 11, wherein the carbide head comprises a single suction channel per transport channel of the drilling tool.

13. The drilling tool according to claim 12, wherein the carbide head comprises at least two suction channels per transport channel of the drilling tool.

14. The drilling tool according to claim 11, wherein the carbide head comprises a single suction channel connected to at least two transport channels of the drilling tool.
